(19) United States
(12) Patent Application Publication
(10) Pub. No.: US 2003/0177504 A1
(43) Pub. Date: Sep. 18, 2003

(54) System and method for synchronizing interaction of a communication network with a broadcasting network

(76) Inventors: Daniel Leonard Paulo, Keller, TX (US); Matthew Richard Piette, Reston, VA (US); Bohdan Myron Pyskir, Naperville, IL (US)

Correspondence Address: MOTOROLA INC, 600 NORTH US HIGHWAY 45, LIBERTYVILLE, IL, 60048-5343, US

(21) Appl. No.: 10/101,764

(22) Filed: Mar. 18, 2002

(51) Int. Cl. H04N 7/173

(52) U.S. Cl. 725/118; 725/106; 725/109; 725/112; 725/123

(57) ABSTRACT

This invention is a system and method for synchronizing interaction of a communication network (206) with a broadcasting network (208). The system (300) comprises a transmission synchronization engine (302), a wireless gateway (118), a program listing source (308, 310, 312), and a program content source (324). The wireless gateway (118) is capable of wireless communication with a mobile station (102) of the communication network (206) and provides location information about the mobile station (102) to the transmission synchronization engine (302). The program listing source (308, 310, 312) is capable of providing a current program listing for broadcast by the broadcasting network (208) based on the location information of the mobile station (102) to the transmission synchronization engine (302). The program content source (324) is capable of providing enhanced program content for one or more programs of the current program listing to the transmission synchronization engine (302). The transmission synchronization engine (302) creates a list of programs from the current program listing having enhanced program content available from the program content source (324), and provides the list to the mobile station (102).

### FIELD OF THE INVENTION

The present invention relates generally to the field of interactive communication with a media broadcaster. In particular, the present invention relates to systems that permit interactive communication with a media broadcaster while receiving related media content from the media broadcaster or other approved sources.

### BACKGROUND OF THE INVENTION

It is generally known that entertainment experiences of the general public may be enhanced by merging and synchronizing two or more existing entertainment networks. For one type of entertainment network, people have been able to view broadcasts on their televisions from broadcasting networks owned by various companies, such as the American Broadcasting Company (“ABC”), the Columbia Broadcasting Server (“CBS”), the National Broadcasting Company (“NBC”), and the Fox Broadcasting Corporation (“FOX”). For another type of entertainment network, people have been able to view Internet content, via the World Wide Web, on their desktop and notebook computers from Internet service and content providers. By combining and synchronizing these entertainment networks, people are also able to view broadcasts on their televisions while, simultaneously, interacting with Internet content on their computers.

Enhanced TV of the ABC's Enhance Television is an interactive television system on the Internet that allows television viewers to interact with ABC broadcasts of television programs, specifically football games and game shows. ABC's Enhanced Television is one of three business units of ABC Internet Group, which has operations in Burbank, Calif. and New York, N.Y. and is part of the ABC Television Network and The Walt Disney Company. A viewer may simultaneously watch an ABC television program and interact with enhanced television content relating to the television program via the Internet. For an ABC broadcast of a football game, for example, the viewer may answer trivia questions, vote on replay challenges, send in comments, and play fantasy football while viewing the football game on the viewer's television. Similarly, while viewing an ABC game show, the viewer at home may play along with the contestants at ABC's television studios in real-time. To use Enhanced TV, the viewer would tune his or her television to an ABC channel, access the ABC web site that corresponds to the ABC channel on his or her computer, and log-in to the Enhanced TV feature of that web site.

In addition to Enhanced TV, a user may also access web sites that include other information of interest to the viewer. For example, TV listings are available via the Internet from TV Guide of 100 Matsonford Road, Radnor, Pa. The user provides his or her zip code to TV Guide's web site and the type of service used for receiving television broadcasts (such as cable, satellite dish, and broadcast/antenna). Based on this information, the web site provides a TV listing corresponding to the zip code and type of service entered by the user. In particular, the web site provides a table identifying television programs that are being broadcast by various local affiliates at various time periods. Unfortunately, such web sites are not integrated or synchronized with the content provided by the broadcasting networks.

Accordingly, there is a need for a system and method that synchronizes interaction of a communication network and a broadcasting network. More particularly, there is a need for a system and method that is capable of integrating and synchronizing various content of a network with content of a communication network and/or broadcasting network. Such system and method would server to further enhance the entertainment experience of users.

### SUMMARY OF THE INVENTION

The present invention is a transmission synchronization engine for synchronizing interaction of a communication network with a broadcasting network. The transmission synchronization engine comprises a location engine, a program listing engine, a program content engine and a processor. The location engine receives location information of a mobile station, the program listing engine retrieves a current program listing based on the location information of the mobile station, and the program content engine retrieves enhanced program content for one or more programs of the current program listing. The processor creates a list of programs from the current program listing corresponding to enhanced program content and provides the list of programs to the mobile station.

The present invention is also a network system for synchronizing interaction of a communication network with a broadcasting network. The network system comprises a transmission synchronization engine as well as a wireless gateway, a program listing source, and a program content source connected to the transmission synchronization engine. The wireless gateway is a part of the communication network, and the program content source is a part of the broadcasting network. The wireless gateway is capable of wireless communication with a mobile station of the communication network and provides location information about the mobile station to the transmission synchronization engine. The program listing source is capable of providing to the transmission synchronization engine a current program listing for broadcast by the broadcasting network based on the location information of the mobile station. The program content source is capable of providing enhanced program content for one or more programs of the current program listing to the transmission synchronization engine. The transmission synchronization engine creates a list of programs from the current program listing having enhanced program content available from the program content source, and provides the list to the mobile station.

The present invention is further a method of a transmission synchronization engine for synchronizing interaction of a communication network with a broadcasting network. The transmission synchronization engine permits access by a mobile station of the communication network via a wireless gateway of the communication network. Next, location information about the mobile station is received from the wireless gateway. A current program listing is then retrieved from a program listing source for broadcast by the broadcasting network based on the location information of the mobile station. Thereafter, enhanced program content for one or more programs of the current program listing is retrieved from a program content source of the broadcasting network. A list of programs from the current program listing having enhanced program content available from the program content source is created. Finally, the list of programs is provided to the mobile station via the wireless gateway.

### BRIEF DESCRIPTION OF THE DRAWINGS

FIG. 1 is a block diagram representing a communication network that may be adapted to operate in accordance with the present invention.

FIG. 2 is a block diagram representing a communication network and a broadcasting network that may be adapted to operate in accordance with the present invention.

FIG. 3 is a block diagram of a preferred embodiment of the present invention that includes a transmission synchronization engine.

FIG. 4 is a flow diagram of a preferred operation of the transmission synchronization engine of FIG. 3 in accordance with the present invention.

FIG. 5 is a flow diagram showing more detail about the step of creating a list of programs identified by the preferred operation of FIG. 4.

FIG. 6 is a flow diagram of more preferred operations of the transmission synchronization engine of FIG. 3 that would follow the preferred operation of FIG. 4.

### DETAILED DESCRIPTION OF THE PREFERRED EMBODIMENT

The present invention is a system and method for synchronizing interaction of a bi-directional network with a unidirectional network. In particular, the system and method synchronizes interaction of a communication network with a broadcasting network. The broadcasting network delivers media content from a program content source, such as a television or radio broadcasting company, to a broadcast receiver, such as a television or radio, located near a user. Similarly, the communication network provides two-way communication between the program content source and a communication transceiver operated by the user. Although the broadcasting network may provide bidirectional capability, the present invention only requires a broadcasting network having uni-directional capability. The user's communication transceiver is, preferably, a mobile station but one skilled in the art will recognize that the features discussed hereinbelow will also find application in other communication devices such as computers, cordless telephones, wireline telephones, personal digital assistants, two-way radios, pagers, and the like, and mobile stations described herein shall refer to each of these and their equivalents.

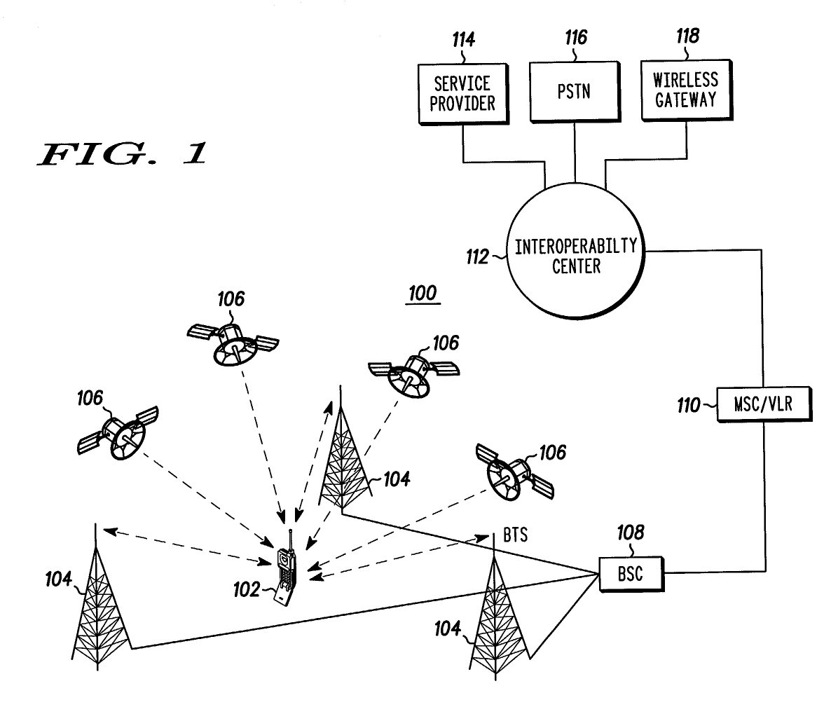

Referring to FIG. 1, there is provided a communication system 100 in accordance with a preferred embodiment of the present invention. The system 100 includes a mobile station 102, base transceiver stations (“BTS's”) 104, and one or more position estimation systems. The BTS's provide a wireless voice and/or data link between the mobile station 102 and various other wired and wireless communication devices.

The communication system 100 may use any type of position estimation system, such as a terrestrial positioning system and a celestial positioning system, to determine the mobile station position. As shown in FIG. 1, the mobile station 102 receives position information from a celestial positioning system, namely global positioning system (“GPS”) satellites 106. The mobile station also determines position information from communication with a terrestrial positioning system, namely BTS's 104. The terrestrial positioning system may utilize a variety of techniques including, but not limited to, a forward link trilateration (“FLT”) technique, an advanced forward link trilateration (“AFLT”) technique, an amplitude difference angle of arrival (“AD-AOA”) technique, and an enhanced observed time difference (“EOTD”) technique. The mobile station 102 may also receive the mobile station position from another entity via a wireless communication link, such as the Bluetooth wireless technology. Examples of such external information include location information referenced and time-stamped off of GPS and/or terrestrial non-FLT, such as an overlay terrestrial location system. Overlay terrestrial location systems are available from third parties such as TruePosition of King of Prussia, Pa. and U.S. Wireless of San Ramon, Calif. The mobile station 102 may autonomously report its position to a wireless infrastructure of the communication system 100, or the wireless infrastructure may query the mobile station to report its position.

The BTS's 104 are part of a wireless infrastructure of the communication system 100. In addition to the BTS's, the wireless infrastructure includes a base station controller (“BSC”) 108, a mobile switching center/visitor location register (“MSC/VLR”) 110, and an interoperability center 112. The BSC 108 controls communication between the BTS's 104, and manages the operation and interaction of the BTS's. The MSC/VLR 110 routes calls to and from the mobile station 102 as well as tracking location information of the mobile stations 102. The interoperability center 112 provides proper conversion of voice and/or data signals of the mobile station 102 to and from another communication protocol, if necessary. For example, the interoperability center 112 may selectively route voice and/or data calls within the communication system as well as to and from a wireless communication service provider 114, a landline voice systems, such as a public switch telephone network (“PSTN”) 116, and a landline data systems, such as an Internet protocol network or wireless gateway 118.

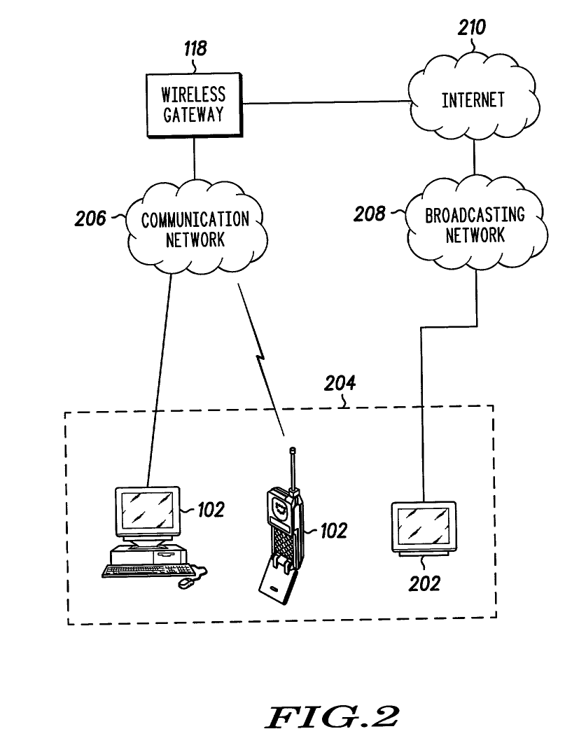

Referring to FIG. 2, a user of the preferred embodiment would receive information from a broadcast receiver 202 while interacting with the mobile station 102. As indicated above, the mobile station 102 herein includes any type of communication device including, but not limited to, computers, cordless telephones, wireline telephones, personal digital assistants, two-way radios, pagers, and the like. The broadcast receiver 202 includes, but is not limited to, video devices (such as a video monitor), audio devices (such as a radio), and multimedia devices (such as a television). The mobile station 102 and the broadcast receiver 202 must be within a particular proximity of the user 204 and, thus, each other. In particular, the mobile station 102 must be close enough to the user to permit interaction with the user, such as listening to the mobile station's earpiece, speaking into the mobile station's mouthpiece, viewing the mobile station's display and/or touching the mobile station's keypad. Likewise, the broadcast receiver 202 must be close enough to the user so that the user may receive information, such as viewing the broadcast receiver's display or hearing the broadcast receiver's speaker. For example, the user may view and listen to his or her television while sending and receiving text messages via his or her mobile station.

For the preferred embodiment, the mobile station 102 communicates with a communication network 206, and the broadcast receiver 202 received information from a broadcasting network 208. The broadcasting network 208, typically operated by a broadcasting television or radio company, provides media content to the broadcast receiver 202. For example, a television broadcasting network would provide audio/visual content to a television, and a radio broadcasting network would provide audio content to a radio. The communication network 206, typically operated by a communication service provider, delivers media content from the broadcasting network 208 to the mobile station 102 while delivering control signals from the mobile station to the broadcasting network. For example, a communication network may communicate text messages or voice messages between a mobile station and a broadcasting network. For the preferred embodiment, shown in FIG. 2, the communication network 206 communicates with the broadcasting network 208 via the wireless gateway 118 and a network connection 210, such as the Internet.

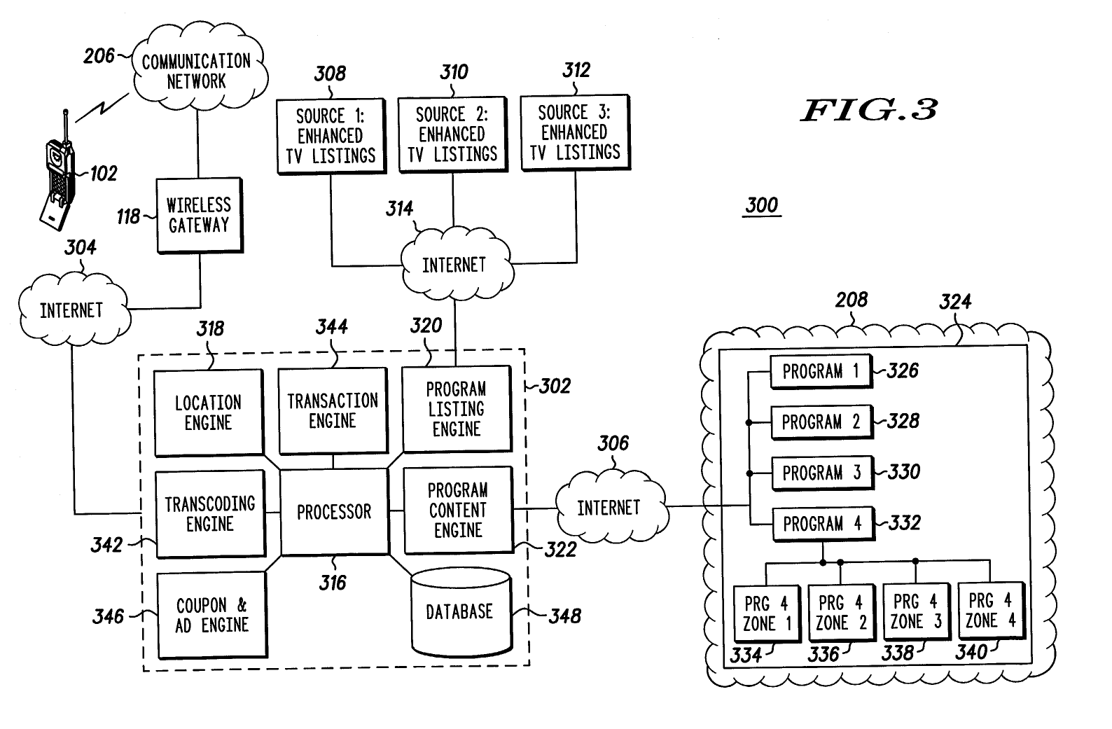

Referring to FIG. 3, the present invention is a network system 300 for synchronizing interaction of the communication network 204 with the broadcasting network 206. The present invention comprises a transmission synchronization engine 302 that is connected to one or more mobile stations 102 via the communication network 204 and a first network connection 304, and is connected one or more broadcasting networks 206 via a second network connection 306. The transmission synchronization engine 302 is further connected to one or more program listing sources 308, 310, 312 via a third network connection 314. The first, second, and third network connections 304, 306, 314 may be any type of data connection link including, but not limited to, an internet, an intranet, a wide area network, a local area network, a wireless communication link, and a direct connection cable. In addition, the communication network 204, the wireless gateway 118, the broadcasting network 206, and the program listing sources 308, 310, 312 may be combined within a single entity, separate from each other, or form one or more separate groups. For the preferred embodiment, the first, second and third network connections 304, 306, 314 represents a portion of the Internet, and the communication network 204, the wireless gateway 118, the broadcasting network 206, and the program listing sources 308, 310, 312 are separate from each other and are communicate with the transmission synchronization engine 302 via the Internet.

The transmission synchronization engine 302 includes a processor 316, a location engine 318, a program listing engine 320, and a program content engine 322. The processor 316 coordinates the operations of the transmission synchronization engine's various components and, otherwise, controls the general operation of the transmission synchronization engine 302. For the preferred embodiment, there is a master-slave relationship between the processor 316 and the other components of the transmission synchronization engine 302. However, it is to be understood that a peer-to-peer or distributed intelligence relationship may be implemented for the components of the transmission synchronization engine 302, thus removing the necessity of having the processor 316.

The location engine 318 identifies the location information of the mobile station 102 for the transmission synchronization engine 302. In particular, the location engine 318 receives location information from the mobile station 102 via the communication network 204 and the wireless gateway 118. Preferably, the location information includes latitude and longitude coordinates of the mobile station's current position. As shown in FIG. 1 and described above, the present invention may use any type of position estimation system, such as a terrestrial positioning system and a celestial positioning system, to determine the mobile station position. The location engine 318 also maps the received location information to a predefined media zone. Since different locations may receive may receive different media content, the media zones are defined so that each media zone receives the similar media content. For example, a television service provider of media zone #1 may broadcast one schedule of television programs, whereas another television service provider of media zone #2 (adjacent to media zone #1) may broadcast a different schedule of television programs.

The location engine 318 may also identify other types of information of the mobile station 102 for the transmission synchronization engine 302. For example, the location engine 318 may receive service mode information that identifies the manner in which media content is broadcast near the mobile station 102, such as via antenna, cable, and satellite reception. For instance, if the mobile station 102 is near a television having a cable connection, the location engine 318 may receive this information about the cable connection from the mobile station 102. In response, the transmission synchronization engine 302 would eliminate from consideration any over-the-air or celestial broadcast at the mobile station's current location, and the transmission synchronization engine would focus any cable broadcast at the mobile station's current location.

The mobile station 102 may determine the above other types of information by user input or by wireless communication with a broadcast receiver. Examples of such wireless communication include, but are not limited to, Bluetooth™ wireless technology which is supported by the Bluetooth™ Special Interest Group, HomeRF™ technology which is supported by the HomeRF™ Working Group, and Wi-Fi (IEEE 802.11, IEEE 802.11b, etc.) technology which is supported by the Institute of Electrical and Electronics Engineers and the Wireless Ethernet Compatibility Alliance. For instance, the mobile station 102 may communicate with a nearby television via Bluetooth technology and determine that the television is receiving media content via satellite reception. Then, the mobile station 102 may forward this service mode information to the location engine 318.

After the transmission synchronization engine 302 receives the location information (and any other information) from the mobile station 102, the program listing engine 320 of the transmission synchronization engine retrieves a current program listing from one or more program listing sources 308, 310, 312. Each program listing source 308, 310, 312 includes various information about media programs, such as program schedules, available from broadcasting networks. Preferably, each program listing source is a web site that provides a list of media programs that are currently being broadcast by a broadcast network to a particular location. The program listing engine 320 may provide the location information of the mobile station 102 to a program listing source 308, 310, 312 and, in response, the program listing source would provide a current program listing to the program listing engine based on the current location. Either the program listing engine 320 or the program listing source 308, 310, 312 may also include a clock circuit to track date and time, so that the program listing engine may retrieve from the program listing source the current program listing based on a present time period as well as the location information of the mobile station 102. The program listing engine 320 may further retrieve the current program listing based on service mode information, retrieved by the location engine 318, that identifies the manner in which media content is broadcast the current location of the mobile station 102, as described above.

For example, the program listing engine 320 may inform a program listing source 308, i.e., a web site, that the mobile station 102 is located at a certain zone (as mapped by the location engine 318) and a television near the mobile station receives media content via cable reception. Based on this information, as well as the current date and time, the web site determines a TV listing of television programs and their corresponding broadcasting networks that are being broadcast at the current date and time. The web site may also determine television programs and their corresponding broadcasting networks that will be broadcast in the near future or have been broadcast in the recent past. The program listing source 308 provides this information to the program listing engine 320 as requested by the program listing engine.

The program content engine 322 retrieves enhanced program content for one or more programs of the current program listing retrieved from the program listing source or sources 308, 310, 312. In particular, the transmission synchronization engine 302, preferably the processor 316, creates a list of programs from the current program listing corresponding to enhanced program content and provides the list of programs to the mobile station 102. The program content engine 322 determines whether the enhanced program content corresponding to the at least one program is available from a program content source 324 of the broadcasting network 208.

The broadcasting network 208 includes the program content source 324 that is connected to the transmission synchronization engine 302. The program content source 324 stores information about various programs of the broadcasting network, such as program 1 through 4 shown in FIG. 3. For example, if the broadcasting network is a television company for providing television broadcasts, the program content source 324 of the broadcasting network may store program content for various television programs that it broadcasts. For instance, a first program 326 may be a particular drama, a second program 328 may be a particular talk show, a third program 330 may be a particular game show and a fourth program 332 may be a particular sporting event. The program content is broadcast for reception by broadcast receivers, and may be available (at least in part) via a network connection, such as network connection 306. Accordingly, it is possible for mobile station 102 to obtain access to at least a portion of the program content of the program content source 324.

The program content source 324 is also capable of providing to the transmission synchronization engine 302 enhanced program content for one or more programs identified by the current program listing. Enhanced program content is additional information that is not broadcast for reception by broadcast receivers, but is available via a network connection, such as network connection 306. A user of the mobile device 102 may access the enhanced program content of the program content source 324 while receiving the broadcasted program content at a broadcast receiver near the mobile device 102. Thus, the enhanced program content as received by the mobile station 102 enhances the user's entertainment experience by providing additional program content to the user, which would not be available to the user solely by the broadcast receiver.

Enhanced program content may take a variety of forms. For example, in the case of enhanced sports content, a sports fan may access specially created content via the mobile station 102 that is synchronized with broadcasting of a sporting event 332. The enhanced sports content may include, but is not limited to, team rosters, player biographical statistics, player and team statistics updated on a regular basis, rule and penalty explanations, trivia, real-time contests, player and coach quotes, promotions and advertisements, and the like. As another example, in the case of enhanced game show content, a game show fan may access, and interact with, specific content via the mobile station 102 that is synchronized with broadcasting of a particular game show 330. The enhanced game show content may include, but is not limited to, score comparisons with other players receiving the enhanced content, a listing of top scorers updated on a regular basis, create a private leaderboard, ability to invite friends to compete each other in groups, ability to create private chat rooms, awarding of prizes, promotions and advertisements, and the like.

Optionally, the program content source 324 may store such information in sub-categories, and these sub-categories may be distinguished based on factors that necessitate differentiating program content. Examples of such sub-categories includes, but are not limited to, differing locations or media zones, differing target users, differing dates or times-of-day, and the like. For example, as represented by FIG. 3, the fourth program 332 may have sub-categories of first, second, third and fourth media zones 334, 336, 338, 340. If, for example, the fourth program 332 represents enhanced media content for a particular sporting event, the first media zone 334 may represent enhanced media content of the particular sporting event for the north-eastern part of the U.S.A., the second media zone 336 may represent enhanced media content of the particular sporting event for the south-eastern part of the U.S.A., the third media zone 338 may represent enhanced media content of the particular sporting event for the north-western part of the U.S.A., and the fourth media zone 340 may represent enhanced media content of the particular sporting event for the north-western part of the U.S.A. For course, it is to be understood that media zone distinction are not limited to those described above, but may be in other forms, such as sub-categories of broadcast zones, cities, counties, states, time zones, regions of common fan loyalty, and the like.

The transmission synchronization engine 302, preferably the processor 316, creates a list of programs from the current program listing corresponding to enhanced program content and provides the list of programs to the mobile station 102. After the program listing engine 320 identifies the current program listing, the transmission synchronization engine 302 determines whether one or more of the programs of the current program listing have corresponding enhanced program content available from the program content source 324. The transmission synchronization engine 302 may make this determination by looking for each program of the current program listing one-by-one at the program content source 324 and, whenever an enhanced program content is found, the corresponding program is added to the list of programs created by the transmission synchronization engine. In the alternative, the program content source 324 may receive the current program listing and identify the programs with corresponding enhanced program content for the transmission synchronization engine 302. Once the list of programs created, the transmission synchronization engine 302 provides the list of programs the mobile station 102 so that the mobile station may display it for its user.

The transmission synchronization engine 302 further includes a transcoding engine 342, a transaction engine 344, an ad engine 346, and a database 348. The transcoding engine 342 transcodes the enhanced program content that is retrieved from the program content source 324 and is intended for the mobile station 102. The enhanced program content is transcoded based on the configuration of the mobile station 102, so that it is presented properly for the user of the mobile station. The configuration of the mobile station 102 may include, but is not limited to, display dimensions, display colors, display language, display graphical capabilities, audio volume, audio frequency range, number of audio channel available, speakerphone capabilities, browser type used by the mobile station 102, and the like. For example, the transcoding engine 342 may modify enhanced program content in the form of WML or XML code intended for a radiotelephone, so that the enhanced program content appears legible and aesthetically pleasing within the dimension of the radiotelephone's display. The transcoding engine 342 may also transcode control signals received from the mobile station 102 and is intended for the program content source 324. The control signals are transcoded based on control input requirements of the broadcasting network 208. For example, the transcoding engine 342 may extract from the control signals essential information, such as a user response and a destination address for the user response, and forward the essential information to the program content source 324.

The transaction engine 344 records interactions between the mobile station 102 and the broadcasting network 208 throughout an interactive session. In particular, the transaction engine 344 records some or all transactions between the mobile station 102 and the program content source 324 from the time an interactive session is initiated to the time the interactive session is terminated.

The ad engine 346 provides one or more advertisements with the list of programs to the mobile station 102. The advertisements may be informative or provide discount opportunities (in the form of a coupon) to the mobile device's user. For the preferred embodiment, the advertisements correlate to a user profile of the mobile device 102, characteristics of the mobile device received from the location engine, programs identified by the list of programs, and/or date and time-of-day. For example, if the list of programs includes a particular sporting event, then the ad engine 346 may provide an advertisement or coupon for sports apparel to the mobile station 102 as the transmission synchronization engine 302 provides the list of programs to the mobile station. The ad engine 346 may also provide an advertisement that entices the user to select a particular program from the list of programs.

The database of the transmission synchronization engine 302 is used to store various information for the transmission synchronization engine 302. Such information includes, but is not limited to, user profiles for each mobile station 102 communicating with the transmission synchronization engine 302, location information and tracking of each mobile station, program preferences of each mobile station, the current program listing retrieved by the program listing engine 320, the enhanced program content retrieved by the program content engine 322, the list of programs created by the transmission synchronization engine 302 (or processor 316), transactions recorded by the transaction engine 344 during each interactive session, advertisements of the ad engine 346, and the like.

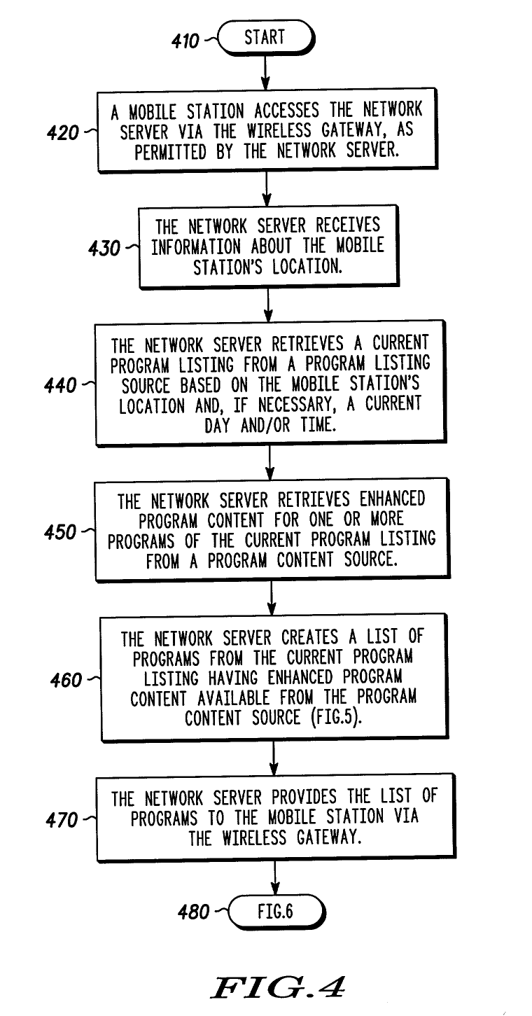

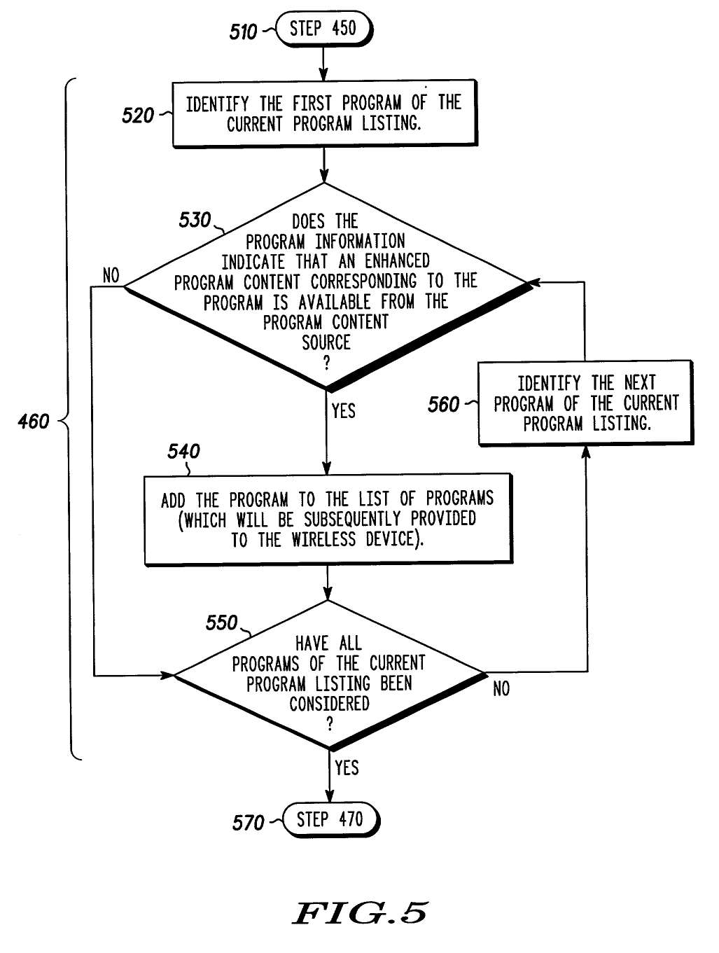

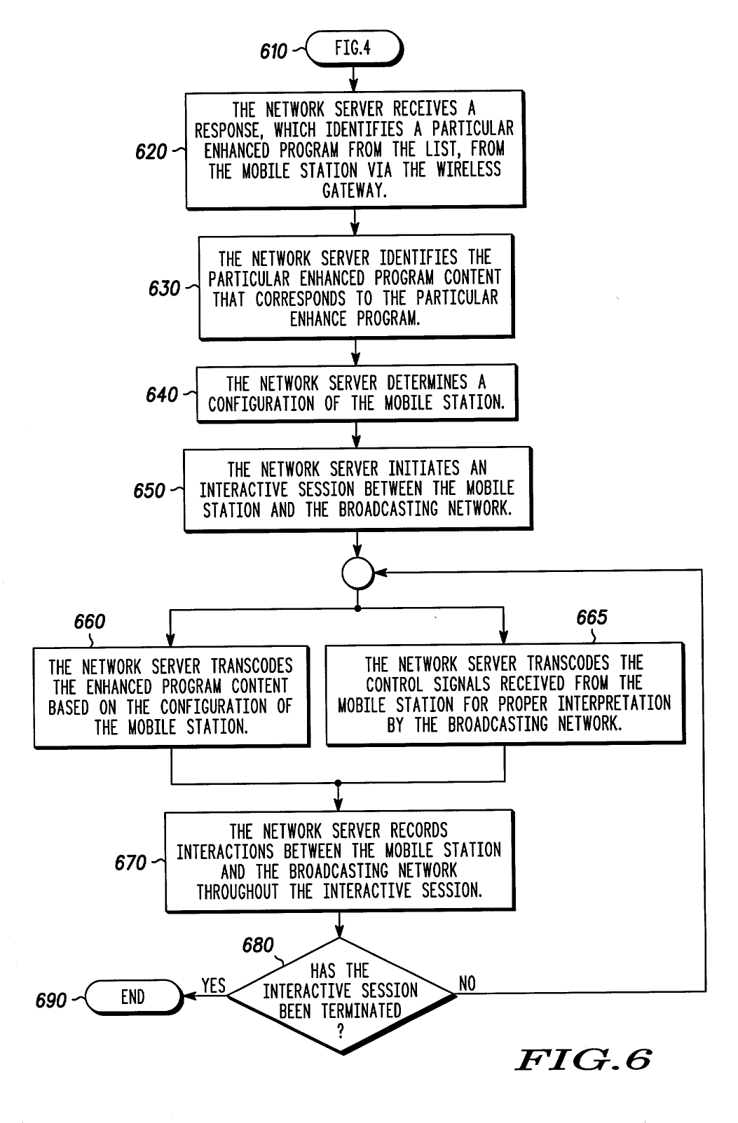

Referring to FIGS. 4 through 6, there are shown flow diagrams representing a preferred procedure for synchronizing interaction of a communication network with a broadcasting network. In particular, FIG. 4 is a flow diagram representing a preferred operation of the transmission synchronization engine 302, FIG. 5 is a flow diagram representing substeps detailing the step of creating a list of programs (i.e., step 460 of FIG. 4), and FIG. 6 is a flow diagram representing additional operations of the transmission synchronization engine that may follow the preferred operation shown in FIG. 4. Preferably, the preferred procedure described herein represents an operation of a transmission synchronization engine, such as the one 302 shown in FIG. 3.

For the preferred embodiment, the processor 316 coordinates the operations of the transmission synchronization engine's various components and, otherwise, controls the general operation of the transmission synchronization engine 302. Therefore, the flow diagrams shown in FIGS. 4 through 6 represent an operation of a transmission synchronization engine having the processor 316. However, as stated above, it is to be understood that the transmission synchronization engine may have a peer-to-peer or distributed intelligence relationship and, thus, the transmission synchronization engine would generally execute the steps shown in FIGS. 4 through 6 without the need for a particular processor to do so.

Referring to FIG. 4 in conjunction with FIG. 3, the preferred procedure begins at step 410. At step 420, a communication connection is made between the transmission synchronization engine 302 and the mobile station 102. For the preferred embodiment, the transmission synchronization engine 302 permits itself to be accessed by the mobile station 102 of the communication network via the wireless gateway 118 of the communication network. In the alternative, the transmission synchronization engine 302 may attempt to contact the mobile station 102, and the mobile station may provide access to the transmission synchronization engine. The transmission synchronization engine 302 then receives location information about the mobile station 102 at step 430. Preferably, the location information includes latitude and longitude coordinates of the mobile station's current position, which is determined by a position estimation system. The location engine 318 may also map the location information to a particular media zone and/or identify other types of information of the mobile station 102 for the transmission synchronization engine 302, such as service mode information that identifies the manner in which media content is broadcast near the mobile station.

The transmission synchronization engine 302 also retrieves a current program listing from a program listing source 324 for broadcast by the broadcasting network 208 based on the location information of the mobile station 102 at step 440. The transmission synchronization engine 302 may retrieve the current program listing based on other information as well, such as service mode information and current day and/or time-of-day. The transmission synchronization engine 302 further retrieves enhanced program content for one or more programs of the current program listing from the program content source 324 of the broadcasting network 208 at step 450.

Next, the transmission synchronization engine 302 creates a list of programs from the current program listing having enhanced program content available from the program content source 324 at step 460. For example, the transmission synchronization engine 302 may look for each program of the current program listing one-by-one at the program content source 324 and, whenever an enhanced program content is found, the corresponding program is added to the list of programs created by the transmission synchronization engine. In the alternative, the program content source 324 may receive the current program listing and identify the programs with corresponding enhanced program content for the transmission synchronization engine 302. Once the list of programs created, the transmission synchronization engine 302 provides the list of programs the mobile station 102 so that the mobile station may display it for its user at step 470. Thereafter, the procedure could terminate at step 480 but, for the preferred procedure, the operation of the transmission synchronization engine 302 continues at with the steps shown in FIG. 6.

Referring to FIG. 5, there is shown more detail about the substeps executed for creating the list of programs in step 460. After initiating the substeps at step 510, the transmission synchronization engine 302 identifies the first program of the current program listing at step 520. Then, at step 530, transmission synchronization engine 302 determines whether the program information indicates that an enhanced program content corresponding to the first program is available from the program content source 324. If enhanced program content corresponding to the first program is available, then the first program is added to the list of programs at step 540. For this particular example, the first program of the current program listing would become the first program of the list of programs. If enhanced program content corresponding to the first program is not available, then the transmission synchronization engine 302 determines whether there is more than one program in the current program listing at step 550. If not, the substeps terminate at step 570 and the transmission synchronization engine 302 continues operation at step 470 shown in FIG. 4.

If the transmission synchronization engine 302 determines that the current program listing includes more than one program, then the transmission synchronization engine identifies the next program of the current program listing at step 560. The transmission synchronization engine 302 then determines whether enhanced program content corresponding to the next program is available from the program content source 324. The next program is added to the list of programs at step 540 if such enhanced program content exists, but the next program is not added to the list of programs if such enhanced program content does not exist. Thereafter, each program of the current program listing is examined (by steps 560, 530 and perhaps 540) until all programs of the current program listing have been reviewed (as determined by step 550. Eventually, the substeps terminate at step 570 and the transmission synchronization engine 302 continues operation at step 470.

Referring to FIG. 6, the transmission synchronization engine 302 continues with additional operations of the procedure at step 610. The transmission synchronization engine 302 receives a response from the mobile station 102 at step 620. The response identifies a particular enhanced program from the list of programs created at step 460. The transmission synchronization engine 302 then identifies the particular enhanced program content that corresponds to the particular enhanced program at step 630. Next, the transmission synchronization engine 302 determines a configuration of the mobile station 102 at step 640. The configuration of the mobile station 102 may be retrieved from the database 348 of the transmission synchronization engine 302 or from a storage component of the mobile station 102. Examples of the configuration information include, but are not limited to, display dimensions, display colors, display language, display graphical capabilities, audio volume, audio frequency range, number of audio channel available, speakerphone capabilities, browser type used by the mobile station 102, and the like. Thereafter, the transmission synchronization engine 302 initiates an interactive session between the mobile station 102 and the broadcasting network 208 at step 650. For the preferred embodiment, the program content engine 322 of the transmission synchronization engine 302 identifies the particular enhanced program content at step 630 and initiates the interactive session at step 650.

After the transmission synchronization engine 302 initiates the interactive session at step 650, the transmission synchronization engine performs certain session-related steps (i.e., steps 660, 665 and/or 670) while periodically checking to determine whether to terminated the session as step 680. In particular, throughout the interactive session, the transmission synchronization engine 302, preferably the transcoding engine 342, transcodes the enhanced program content based on the configuration of the mobile station 102 at step 660 and transcodes the control signals received from the mobile station for proper interpretation by the broadcasting network 208 at step 665.

It is to be understood that steps 660 and 665 may occur sequentially or simultaneously. Also, throughout the interactive session, the transmission synchronization engine 302, preferably the transaction engine 344, records interactions between the mobile station 102 and the broadcasting network 208 at step 670. When the transmission synchronization engine 302 determines that the interactive session has been terminated at step 680, the additional operation shown in FIG. 6 terminates at step 690.

While the preferred embodiment of the invention has been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A transmission synchronization engine for synchronizing interaction of a communication network with a broadcasting network comprising:
a location engine for receiving location information of a mobile station;
a program listing engine for retrieving a current program listing based on the location information of the mobile station;
a program content engine for retrieving enhanced program content for at least one program of the current program listing; and
a processor for creating a list of programs from the current program listing corresponding to enhanced program content and providing the list of programs to the mobile station.

2. The transmission synchronization engine of claim 1, wherein the program listing engine retrieves the current program listing based on a present time period as well as the location information of the mobile station.

3. The transmission synchronization engine of claim 1, further comprising a transcoding engine for transcoding the enhanced program content intended for the mobile station based on the configuration of the mobile station, and transcoding control signals received from the mobile station based on control input requirements of the broadcasting network.

4. The transmission synchronization engine of claim 1, further comprising a transaction engine for recording interactions between the mobile station and the broadcasting network throughout an interactive session.

5. The transmission synchronization engine of claim 1, further comprising an ad engine for providing at least one advertisement with the list of programs to the mobile station.

6. A network system for synchronizing interaction of a communication network with a broadcasting network comprising:
a transmission synchronization engine;
a wireless gateway of the communication network connected to the transmission synchronization engine, the wireless gateway being capable of wireless communication with a mobile station of the communication network and providing location information of the mobile station to the transmission synchronization engine;
a program listing source connected to the transmission synchronization engine, the program listing source being capable of providing to the transmission synchronization engine a current program listing for broadcast by the broadcasting network based on the location information of the mobile station; and
a program content source of the broadcasting network connected to the transmission synchronization engine, the program content source being capable of providing enhanced program content for at least one program of the current program listing to the transmission synchronization engine,
wherein the transmission synchronization engine creates a list of programs from the current program listing having enhanced program content available from the program content source and provides the list to the mobile station.

7. The network system of claim 6, wherein the program listing source provides the current program listing based on a present time period as well as the location information of the mobile station.

8. The network system of claim 6, wherein the transmission synchronization engine transcodes the enhanced program content intended for the mobile station based on the configuration of the mobile station, and transcodes control signals received from the mobile station based on control input requirements of the broadcasting network.

9. The network system of claim 6, wherein the transmission synchronization engine records interactions between the mobile station and the broadcasting network throughout an interactive session.

10. The network system of claim 6, wherein the transmission synchronization engine provides at least one advertisement with the list of programs to the mobile station.

11. A method of a transmission synchronization engine for synchronizing interaction of a communication network with a broadcasting network comprising the steps of:
permitting access to the transmission synchronization engine by a mobile station of the communication network via a wireless gateway of the communication network;
receiving location information of the mobile station from the wireless gateway;
retrieving a current program listing from a program listing source for broadcast by the broadcasting network based on the location information of the mobile station;
retrieving enhanced program content for at least one program of the current program listing from a program content source of the broadcasting network;
creating a list of programs from the current program listing having enhanced program content available from the program content source; and
providing the list of programs to the mobile station via the wireless gateway.

12. The method of claim 11, wherein the step of creating the list of programs from the current program listing includes the step of determining whether the enhanced program content corresponding to the at least one program is available from the program content source.

13. The method of claim 11, further comprising the step of receiving a response from the mobile station via the wireless gateway, wherein the response identifies a particular enhanced program of the list of programs.

14. The method of claim 13, further comprising the steps of:
identifying the particular enhanced program content that corresponds to the particular enhanced program; and
providing at least a portion of the particular enhanced program content to the mobile station.

15. The method of claim 11, further comprising the step of determining a configuration of the mobile station.

16. The method of claim 15, wherein the step of determining the configuration of the mobile station includes the step of retrieving the configuration from a database of the transmission synchronization engine.

17. The method of claim 15, wherein the step of determining the configuration of the mobile station includes the step of retrieving the configuration from the mobile station.

18. The method of claim 15, wherein the configuration includes a browser type used by the mobile station.

19. The method of claim 11, further comprising the steps of:
initiating an interactive session between the mobile station and the broadcasting network; and
recording interactions between the mobile station and the broadcasting network throughout the interactive session.

20. The method of claim 11, further comprising the steps of:
transcoding the enhanced program content intended for the mobile station based on the configuration of the mobile station; and
transcoding control signals received from the mobile station based on control input requirements of the broadcasting network.
